(19) United States
(12) Patent Application Publication
(10) Pub. No.: US 2023/0194367 A1
(43) Pub. Date: Jun. 22, 2023

(54) INTEGRATED SENSORS TO PROVIDE CONTINUAL FEEDBACK

(71) Applicant: Carrier Corporation, Palm Beach Gardens, FL (US)

(72) Inventors: Srinivasa Reddy Pilli, Hyderabad (IN); Karimulla Shaik, Hyderabad (IN); Sridhar Kumar Sridhar Kumar, Hyderabad (IN); Vinayak Rao Eluri, Hyderabad (IN); Ashoka Thimma Reddy, Hyderabad (IN); Pradeep Kumar Sappati, Hyderabad (IN); Dinesh Sanapala, Hyderabad (IN)

(21) Appl. No.: 18/075,827

(22) Filed: Dec. 6, 2022

Related U.S. Application Data
(60) Provisional application No. 63/292,066, filed on Dec. 21, 2021.

(51) Int. Cl. G01L 1/24; G01K 11/32

(52) U.S. Cl. CPC G01L 1/242; G01K 11/32; F25B 49/02

(57) ABSTRACT

A method and system for utilizing integrated fiber optic sensors to provide continuous feedback. A method includes receiving sensor data from a plurality of fiber optic sensors, aggregating first fiber optic cables corresponding to the plurality of fiber optic sensors, and transmitting the sensor data through a second fiber optic cable to a connector.

### CROSS REFERENCE TO RELATED APPLICATIONS

This application claims the benefit of U.S. Provisional Application No. 63/292,066 filed Dec. 21, 2021, the disclosure of which is incorporated herein by reference in its entirety.

### BACKGROUND

The present disclosure relates to sensors, and more specifically, to integrated multiplicity sensors to provide continual feedback.

In today’s environment, various systems such as heating, ventilation, and air condition (HVAC) systems are monitored for proper operation. For example, temperature and pressure conditions are measured at different points in the system. The data can be monitored over time and used to identify abnormal conditions in the system. There may be a need to continuously monitor the various conditions.

### BRIEF DESCRIPTION

According to an embodiment, an integrated sensor for providing continual feedback is provided. The integrated sensors may comprise a plurality of fiber optic sensors, wherein the plurality of fiber optic sensors is configured to monitor refrigeration properties; and an aggregation point configured to aggregate first fiber optic cables corresponding to the plurality of fiber optic sensors; an aggregated fiber optic cable comprising the first fiber optic cables; and a connector coupled to the aggregated fiber optic cable configured to provide sensor data from the plurality of fiber optic sensors.

In addition to one or more of the features described herein, or as an alternative, further embodiments include a single light source, wherein a plurality of fiber optic sensors utilizes a single light source.

In addition to one or more of the features described herein, or as an alternative, further embodiments include each of the plurality of fiber optic sensors is configured to measure pressure and temperature.

In addition to one or more of the features described herein, or as an alternative, further embodiments include measuring pressure based on a strain measurement.

In addition to one or more of the features described herein, or as an alternative, further embodiments include measuring pressure based on the strain measurement and a light reflection measurement.

In addition to one or more of the features described herein, or as an alternative, further embodiments include measuring temperature based on a light reflection measurement.

In addition to one or more of the features described herein, or as an alternative, further embodiments include a controller that is configured to receive the sensor data from the connector to perform measurements for pressure and temperature.

In addition to one or more of the features described herein, or as an alternative, further embodiments include using a plurality of fiber optic sensors configured to continuously monitor one or more conditions of a refrigeration system.

According to an embodiment, a method for utilizing a plurality of fiber optic sensors is provided. The method comprises receiving sensor data from a plurality of fiber optic sensors; aggregating first fiber optic cables corresponding to the plurality of fiber optic sensors; and transmitting the sensor data through a second fiber optic cable to a connector.

In addition to one or more of the features described herein, or as an alternative, further embodiments include a plurality of fiber optic sensors that utilizes a single light source.

In addition to one or more of the features described herein, or as an alternative, further embodiments include connecting the connector to a control board, wherein the second fiber optic cable comprises the connector.

In addition to one or more of the features described herein, or as an alternative, further embodiments include measuring, using the plurality of fiber optic sensors, pressure and temperature of a refrigeration system.

In addition to one or more of the features described herein, or as an alternative, further embodiments include measuring the pressure based on a strain measurement.

In addition to one or more of the features described herein, or as an alternative, further embodiments include measuring the pressure based on the strain measurement and a light reflection measurement.

In addition to one or more of the features described herein, or as an alternative, further embodiments include measuring the temperature based on a light reflection measurement.

In addition to one or more of the features described herein, or as an alternative, further embodiments include receiving the sensor data from the connector to perform measurements for pressure and temperature.

In addition to one or more of the features described herein, or as an alternative, further embodiments include continuously monitoring one or more conditions of a refrigeration system.

The foregoing features and elements may be combined in various combinations without exclusivity, unless expressly indicated otherwise. These features and elements as well as the operation thereof will become more apparent considering the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 depicts an example system using the integrated fiber optical signals in accordance with one or more embodiments of the disclosure;

FIG. 2 depicts example methods for performing the measurements for the various refrigeration properties of the system in accordance with one or more embodiments of the disclosure;

FIG. 3 depicts an example harness used in the system in accordance with one or more embodiments of the disclosure;

FIG. 4 depicts an example controller that may be coupled to the harness in accordance with one or more embodiments of the disclosure; and

FIG. 5 depicts a flowchart of a method for providing continuous feedback using integrated fiber optical fiber signals in accordance with one or more embodiments of the disclosure.

### DETAILED DESCRIPTION

Many systems can use sensors to monitor various conditions during operation. Numerous sensors may be used to monitor the different conditions. Each sensor that is deployed in the field can consume large amounts of power (i.e., 24 V per sensor). Also, different types of sensors are required to measure different parameters such as temperature, pressure, etc. In one example, 5 different sensors may be used to measure different refrigeration properties in the unit. Also, a multiport wire harness may be required to interface to the control board to process the sensor data which requires a larger control board that comprises the appropriate input ports for each of the sensors.

The techniques described herein provide a low-power fiber optic sensor solution that integrates a plurality of sensors within a single harness which substantially reduces the power consumption and required space. In addition, the optic-fiber sensors are more robust against interference from radiation and or temperature changes than conventional copper-based cables.

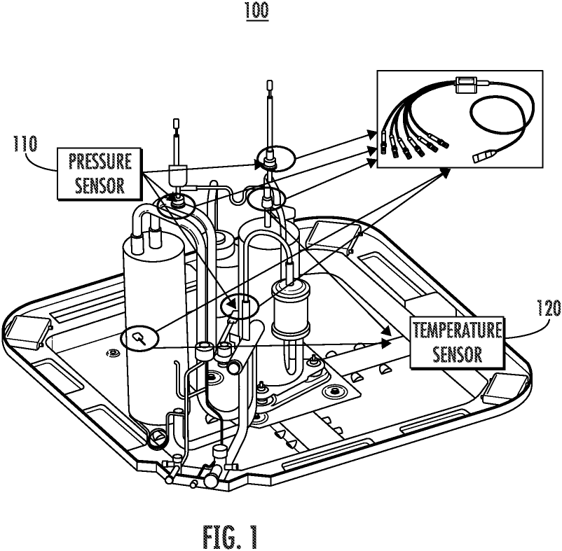

Now referring to FIG. 1, a system 100 such as a refrigeration system comprises various equipment, fluids, and processes for operation. Various temperatures and pressures can be measured at different points in the system for monitoring using pressure sensors 110 and temperature sensors 120. The refrigeration systems can include equipment such as compressors, evaporators, condensers, etc. Sensors can be arranged within the system 100 to monitor the temperature and pressure. In one or more embodiments of the disclosure, optical fiber-based sensors are used. For example, the sensor can include a high side pressure sensor, low side pressure sensor, temperature sensors (OAT, OCT, defrost), etc.

Each of the light sensors may comprises a light source, transmitting fiber, receiving fiber, detector, etc. Each of the optical fiber sensors measure temperature by determining the thermal radiation emitted by the object and/or surface.

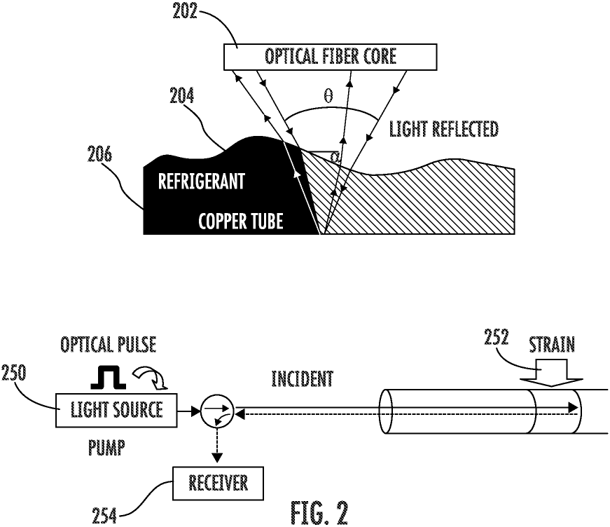

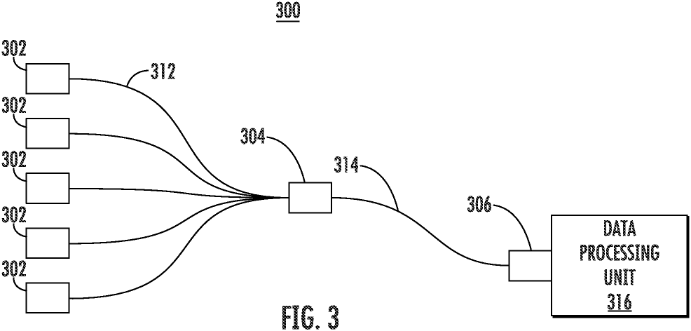

Now referring to FIG. 2, the optic fiber-based sensors can be used to perform measurements using multiple techniques. As shown in FIG. 2, a first technique is illustrated that measures the light reflection from a surface. In the non-limiting example, the light source is provided through an optical fiber core 202 and emitted on the refrigerant 204 within a copper tube 206. The light source emits a light signal having a known wavelength. The light is reflected off the surface which modifies the wavelength of the light and is reflected back to the fiber optic sensor can be used to provide an indication of pressure and/or temperature. The wavelength of the light signal is modulated based on the temperature, i.e., temperature of the refrigerant in this example, and provides an indication of the pressure and/or temperature. In one or more embodiments, a detector can be used to convert the light signal into a current signal which can be processed by a data processing unit such as that shown with reference to FIG. 3.

FIG. 2 also depicts a second technique that utilizes the fiber optic-based sensor to measure pressure using strain. A light source 250 provides an optical pulse through a fiber optic cable. The strain 252 provides an indication of pressure and modulates the light signal based on the amount of strain. The modulated light signal is returned to the receiver 254. In one or more embodiments of the disclosure, the modulated light signal is further processed by a data processing unit.

In some embodiments, the first technique is used, and in another embodiment, the second technique is used to provide information of a measured condition. In yet a further embodiment, the first and second techniques may be used to perform for performing each of the measurements.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

FIG. 3 illustrates a fiber optic cable and harness in accordance with one or more embodiments of the disclosure. The harness as shown in FIG. 3 comprises a plurality of fiber optic cables in accordance with one or more embodiments. In this non-limiting example, 5 fiber optic cables are shown. It should be appreciated that more fiber optic cables, or fewer fiber optic cables can be incorporated into the harness and is not limited by the examples described herein. Harness 300 comprises a plurality of fiber optical sensors 302 that are integrated within a unit in accordance with one or more embodiments of the disclosure is shown. In this non-limiting example, 5 optic fiber-based sensors 302 are integrated into a single unit. Each of the sensors 302 can perform measurements using the first and/or techniques. The fiber optic cables 312 (first fiber optic cables) corresponding to each of the sensors 302 are combined at the aggregation point 304. The fiber optic cable 314 (second fiber optic cable) is coupled to the aggregation point 304 and combines the plurality of fiber optic cables 312 in a single enclosed cable. The fiber optic cable 314 includes a connector 306 that is configured to provide a connection to a control board or a data processing unit. The connector 306 can transmit the data for each of the sensors 302 through the single connection.

The optical fiber-based sensors 302 can include but are not limited to pressure sensors, temperature sensors, etc. For pressure sensing, the detection utilizes both strain and the reflection of light to determine the pressure condition.

In one or more embodiments of the disclosure, a single light source may be used for each of the sensors 302 for detecting a condition. The light source can be used to transmit a light signal having a known wavelength through each of the fiber optic cables 312.

Each of the sensors is configured to detect the reflected wavelength off the surface and transmit the light information to the controller or data processing unit through the fiber optic cables 312 and 314. For example, the light signal may reflect off of the surface of a refrigerant or a pipe to determine the temperature. In one or more embodiments of the disclosure, the detector may be configured to convert the light into current. It should be understood that other types of detectors such as a photodiode may be used.

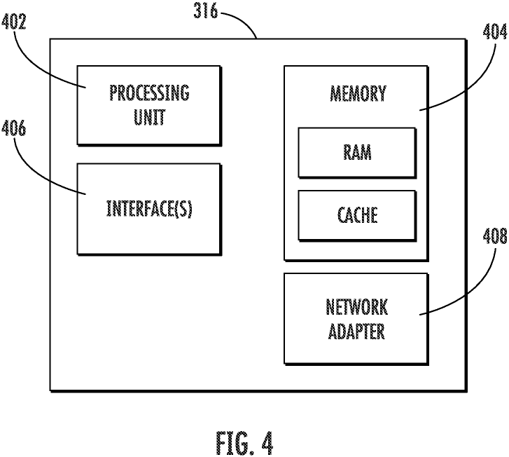

FIG. 4 depicts an example data processing unit 316 for processing the sensor data from the fiber optical sensors 302 in accordance with one or more embodiments of the disclosure. Referring now to FIG. 4, in which an exemplary data processing unit 316 of FIG. 3, that is used to implement the embodiments of the present disclosure is shown. Data processing unit 316 is only illustrative and is not intended to suggest any limitation as to the scope of use or functionality of embodiments of the invention described herein.

As shown in FIG. 4, the data processing unit 316 is shown in the form of a general-purpose computing device. The components of the data processing unit 316 may include, but are not limited to, one or more processors 402, a memory 404, interface 406, and network adapter 408. In one or more embodiments of the disclosure, the processor 402 can include a processor 402 of a general-purpose computer, special purpose computer, or other programmable data processing apparatus configured to execute instruction via the processor of the computer or other programmable data processing apparatus.

Data processing unit 316 can include a variety of computer system readable media. Such media may be any available media that is accessible by data processing unit 316, and it includes both volatile and non-volatile media, removable and non-removable media. Memory 404 can include computer system readable media. The memory 404 can include any one or combination of volatile memory elements (e.g., random access memory (RAM, such as DRAM, SRAM, SDRAM, etc.)) and nonvolatile memory elements (e.g., ROM, erasable programmable read-only memory (EPROM), electronically erasable programmable read-only memory (EEPROM), etc.). Node 400 may further include other removable/non-removable, volatile/non-volatile computer system storage media.

The memory 404 may include one or more program modules (not shown) such as operating system(s), one or more application programs, other program modules, and program data. Each of the operating systems, one or more application programs, other program modules, and program data or some combination thereof, may include an implementation of a networking environment. The program modules generally carry out the functions and/or methodologies of embodiments of the invention as described herein.

Data processing unit 316 may also communicate with one or more external devices through the interface 406 such as a keyboard, a pointing device, a display, etc.; one or more devices that enable a user to interact with node 400; and/or any devices (e.g., network card, modem, etc.) that enable node 400 to communicate with one or more other computing devices.

Still yet, data processing unit 316 can communicate with one or more networks such as a local area network (LAN), a general wide area network (WAN), and/or a public network (e.g., the Internet) via network adapter 408. As depicted, network adapter 208 communicates with the other components of data processing unit 316. It should be understood that although not shown, other hardware and/or software components could be used in conjunction with data processing unit 316. It can be appreciated the node 400 can include other components or modules and is not limited by the components shown in FIGS. 1, 2, and 3.

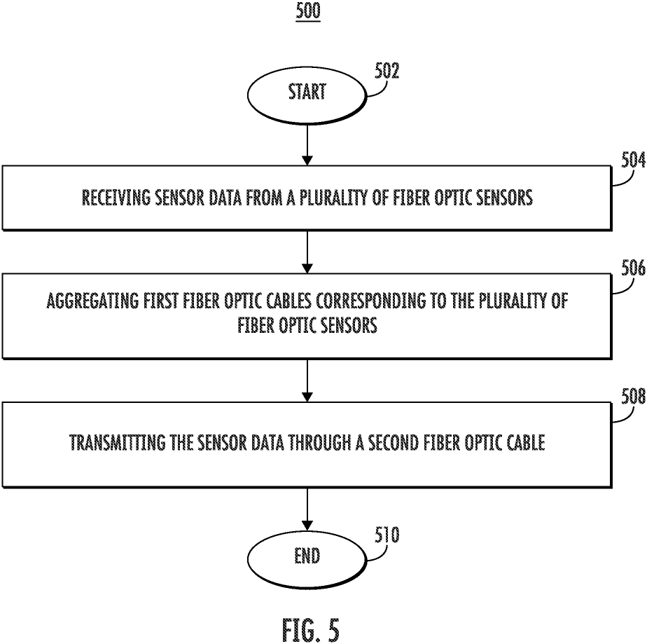

FIG. 5 depicts a method 500 for utilizing the harness 300 comprising a plurality of integrated fiber optic sensors in accordance with one or more embodiments of the disclosure. The method 500 begins at block 502 and proceeds to block 504, which discloses receiving sensor data from a plurality of fiber optic sensors. The fiber optic sensors may use the same light source.

In some embodiments, the harness 300 may be used to continuously monitoring one or more conditions of a refrigeration system. In other embodiments, the harness 300 may be used to periodically monitor the conditions.

At block 506, the sensor aggregates first fiber optic cables corresponding to each of the plurality of fiber optic sensors. At block 508, the integrated sensor transmits the sensor data through a second fiber optic cable to a data processing unit. The data processing unit is configured to receive the sensor data from the connector to perform measurements for pressure and temperature. In one or more embodiments of the disclosure, the data processing unit may include a control board comprising a connection for connecting the integrated sensor to the control board, wherein the second fiber optic cable comprises the connector.

In one or more embodiments, the sensor data obtained using the fiber optic sensors and the data processing unit is to measure the pressure and temperature of a refrigeration system. The pressure can be determined based on a strain measurement. In another embodiment, the pressure can be determined based on the strain measurement and a light reflection measurement. The pressure can be determined based on a light reflection measurement.

In one or more embodiments of the disclosure, the harness combines fiber optic cables into a single cable. For example, a single sheath may enclose the individual fiber optic cables for the sensors. The method 500 ends at block 510. The process flow diagram of FIG. 5 is not intended to indicate that the operations of the method 500 are to be executed in any particular order, or that all of the operations of the method 500 are to be included in every case. Additionally, the method 500 can include any suitable number of additional operations.

The technical effects and benefits include minimizing the energy usage by a device with improved performance. Current sensing devices may be used to measure various refrigerant properties like pressure, temperature, etc., consume generous amounts of energy and requires complicated wire harness to connect to the control board which size can be reduced due to only requiring a single input port. The fiber optic sensors offer a high speed, low-latency solution for performing sensor measurement in various environment. The fiber optic sensors are resistant to temperature effects from the environment as opposed to copper wire.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An integrated sensor for providing continual feedback, the integrated sensors comprising:
a plurality of fiber optic sensors, wherein the plurality of fiber optic sensors is configured to monitor refrigeration properties;
an aggregation point configured to aggregate first fiber optic cables corresponding to the plurality of fiber optic sensors;
an aggregated fiber optic cable comprising the first fiber optic cables; and
a connector coupled to the aggregated fiber optic cable configured to provide sensor data from the plurality of fiber optic sensors.

2. The integrated sensor of claim 1, further comprising a single light source, wherein the plurality of fiber optic sensors utilizes a single light source.

3. The integrated sensor of claim 1, wherein each of the plurality of fiber optic sensors is configured to measure pressure and temperature.

4. The integrated sensor of claim 3, wherein the measured pressure is based on a strain measurement.

5. The integrated sensor of claim 4, wherein the measured pressure is based on the strain measurement and a light reflection measurement.

6. The integrated sensor of claim 3, wherein the measured temperature is based on a light reflection measurement.

7. The integrated sensor of claim 1, further comprising a controller configured to receive the sensor data from the connector to perform measurements for pressure and temperature.

8. The integrated sensor of claim 1, wherein the plurality of fiber optic sensors is configured to continuously monitor one or more conditions of a refrigeration system.

9. A method for utilizing a plurality of fiber optic sensors, the method comprising:
receiving sensor data from a plurality of fiber optic sensors;
aggregating first fiber optic cables corresponding to the plurality of fiber optic sensors; and
transmitting the sensor data through a second fiber optic cable to a connector.

10. The method of claim 9, wherein the plurality of fiber optic sensors utilizes a single light source.

11. The method of claim 9, further comprising connecting the connector to a control board, wherein the second fiber optic cable comprises the connector.

12. The method of claim 9, further comprising measuring, using the plurality of fiber optic sensors, pressure and temperature of a refrigeration system.

13. The method of claim 12, wherein measuring the pressure is based on a strain measurement.

14. The method of claim 13, wherein measuring the pressure is based on the strain measurement and a light reflection measurement.

15. The method of claim 13, wherein measuring the temperature is based on a light reflection measurement.

16. The method of claim 9, further comprising receiving the sensor data from the connector to perform measurements for pressure and temperature.

17. The method of claim 9, further comprising continuously monitoring one or more conditions of a refrigeration system.
